(19) United States
(12) Patent Application Publication
(10) Pub. No.: US 2005/0172834 A1
(43) Pub. Date: Aug. 11, 2005

(54) Vacuum packing machine

(76) Inventor: Kyul-Joo Lee, Kyonggido (KR)

Correspondence Address: PERKINS COIE LLP, P.O. BOX 2168, MENLO PARK, CA, 94026, US

(21) Appl. No.: 10/503,209

(22) PCT Filed: Jan. 30, 2003
(86) PCT No.: PCT/KR03/00215

(30) Foreign Application Priority Data
Feb. 1, 2002 (KR) 10-2002-0005945

(51) Int. Cl. A23B 4/00

(52) U.S. Cl. 99/472

(57) ABSTRACT

Disclosed herein is a vacuum packing machine. The vacuum packing machine (1) includes a housing body (100), a top cover (200), a thermal sealing means (300), a base (400), and a vacuum pressure generating means (500). The housing body (100) has a longitudinal partition wall (2), a cylinder (3), an exhaust passage (4), a sucking passage (5), an air-channeled panel (6), an edge groove (7), a guide groove (8), a first blocks (10), a shaft bearing (11), and support holes (12). The top cover (200) covers the upper part of the housing body (100). The thermal sealing means (300) seals a packing bag (A). The base (400) includes two second hinge blocks (41), a holder (42), second seating grooves (43), and support members (44). The vacuum pressure generating means (500) includes a drive motor (51), a crank shaft (52), and a piston (53).

### TECHNICAL FIELD

The present invention relates generally to a vacuum packing machine, and more particularly, to a vacuum packing machine which has an improved structure of a vacuum pressure generating means for generating vacuum pressure in a housing body, thus enhancing the efficiency of generating vacuum pressure, minimizing an overload caused by the generated vacuum pressure, and allowing easy packing of a packing bag containing contents therein.

### BACKGROUND ART

As well known to those skilled in the art, vacuum packing is widely used to pack food items. Such vacuum packing maintains the freshness of packed food, and lengthens the distribution period of food. In addition, the vacuum packing prevents food from being oxidized in air and prevents moisture contained in the food from evaporating, thus preventing weight of food from being reduced, preserving food from decaying, suppressing the growth of microorganisms, and preserving the inherent taste and odor of food for a lengthy period of time. Thus, vacuum packing has been increasingly used in the food processing field and in homes.

A vacuum packing machine is used for packing food, such as meat and other items, under vacuum such that food and other items are preserved for a lengthy period of time. The vacuum packing machine has been classified into two types, that is, an industrial packing machine and a household packing machine which is portable. Vacuum packing processes differ according to the kinds of packing bags.

Each packing bag is open at an end thereof so as to receive items. An air channel is formed on the inner surface of the packing bag so as to easily discharge air from the packing bag to the outside during a vacuum packing process.

Typically, the household vacuum packing machine mainly uses a packing bag whose inner surface has an air channel.

Such a vacuum packing machine is disclosed in Korean Pat. Application No. 2001-10585, which was invented by the inventor of the present invention, and filed on Feb. 28, 2001 and is entitled “PORTABLE VACUUM PACKAGING MACHINE”.

The vacuum packing machine includes a head which is connected to a main body of a separate vacuum pump through a connecting pipe. The head consists of a top cover and a base. An actuating switch, an actuating lamp, and vacuum level control buttons are installed on the top cover. The base is provided on its bottom with support legs. A chamber and a thermal sealing unit are also provided on the base. In this case, the chamber has an air sucking port connected to the connecting pipe and a gauge inlet port. The thermal sealing unit is used to finally seal the open end of the packing bag.

The conventional vacuum packing machine is operated such that vacuum pressure generated in the main body of the separate vacuum pump is applied to the head through the connecting pipe, and air of the packing bag is discharged through the open end of the packing bag to the outside by the vacuum pressure generated in the chamber under the head, while simultaneously sealing the open end of the packing bag by means of the thermal sealing unit, thus finishing the vacuum packing of the packing bag.

Since the above vacuum packing machine must be used with the separate vacuum pump, the vacuum packing machine is not suitable for home use, but is used in large supermarkets and department stores only.

In order to solve such a problem, there have been proposed a variety of vacuum packing machines integrated with vacuum pumps. However, such a vacuum packing machine has a problem that the vacuum pump must be integrally installed in the vacuum packing machine, so its size becomes excessively large. Since the vacuum packing machine has an excessively large size, it is difficult to hold it in a user's hand. Thus, the vacuum packing machine is typically used as it is fixed to a sink in a kitchen. That is, the vacuum packing machine is not a portable but a countertop-machine having a large volume.

Therefore, a large space is required for installing the vacuum packing machine, so it is difficult to use the vacuum packing machine in a limited space.

The conventional vacuum packing machine is designed such that a drive motor and a small vacuum pumping unit are installed therein, and the vacuum pumping unit is connected to a vacuum leading hose and a vacuum releasing hose which extend to the lower portion of the vacuum packing machine. In this case, the vacuum leading hose and the vacuum releasing hose must be arranged without being bent, so the vacuum packing machine has to be carefully designed considering the other elements to be installed therein without interfering with the straight hoses. In addition, the vacuum pressure generated in the vacuum pumping unit passes the vacuum leading hose, so a loss is caused by the hose, and real vacuum pressure may be lower than ideal vacuum pressure.

That is, since the eccentric rotating range of the eccentric pump-type vacuum pumping unit for sucking and exhausting air is limited, the maximum pumping capacity is reduced, and the real vacuum pressure becomes lower than the ideal vacuum pressure. On the contrary, when the vacuum pumping unit is operated to forcibly generate vacuum pressure exceeding a preset level, the vacuum pumping unit and the drive motor are overloaded, so the efficiency of vacuum packing is reduced.

### DISCLOSURE OF THE INVENTION

Accordingly, the present invention has been made keeping in mind the above problems occurring in the prior art, and an object of the present invention is to provide a vacuum packing machine, which generates desired vacuum pressure by a vacuum pressure generating means provided in a housing body minimizes the overload caused by the generated vacuum pressure, and makes it easy and simple to perform a vacuum packing process.

In order to accomplish the above object, the present invention provides a vacuum packing machine, comprising: a housing body including a longitudinal partition wall having a cylinder block, with first and second depressions formed on the housing body at both sides of said partition wall, a cylinder horizontally set in said cylinder block of the partition wall, an exhaust passage extending from the cylinder to an upper surface of the cylinder block, a sucking passage extending from a lower surface of the housing body to the cylinder, an air-channeled panel provided on the lower surface of the housing body at a position corresponding to the sucking passage for creating an air path, an edge groove formed on the lower surface of the housing body along an edge of the air-channeled panel, with a sealing member being installed along the edge groove, a guide groove of a predetermined depth formed on the lower surface of the housing body at a predetermined position spaced apart from the air-channeled panel by a predetermined distance, a first seating groove of a predetermined depth longitudinally formed on the lower surface of the housing body at a position around the guide groove, two first hinge blocks projected at two positions of an upper surface of the housing body, a shaft bearing provided at a predetermined position between the two first hinge blocks, and support holes formed on the lower surface of the housing body to have a predetermined depth; a top cover covering an upper part of the housing body, and provided with a power switch and a plurality of vacuum level control buttons electrically connected to the power switch; a thermal sealing means longitudinally installed on the lower surface of the housing body at a front portion for sealing an open end of a packing bag; a base including two second hinge blocks provided at two positions of an upper surface of the base to join with the first hinge blocks provided on the upper surface of the housing body, a holder installed on the base such that both ends of the holder are rotatably set on both side edges of the base, and holding a predetermined portion of the packing bag, second seating grooves formed on the both side edges of the base for allowing the both ends of the holder to be positioned nearly horizontally, support members provided on the base at positions around the second hinge blocks and normally biasing the housing body upward to position the body at an open position with a predetermined open angle; and a vacuum pressure generating means including a drive motor mounted on the first depression of the housing body, a crank shaft connected at a first end thereof to a rotating shaft of the drive motor, and supported at a second end thereof by the shaft bearing of the housing body, and a piston connected at an end thereof to the crank shaft, and set in the cylinder.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a vacuum packing machine according to the present invention;

FIG. 2 is a perspective view of the vacuum packing machine of the present invention, horizontally broken away to show the interior construction;

FIG. 3 is a partially sectioned plan view of the vacuum packing machine according to the present invention;

FIG. 4 is a sectional perspective view of the vacuum packing machine according to the present invention, with a sucking passage of a housing body cut away;

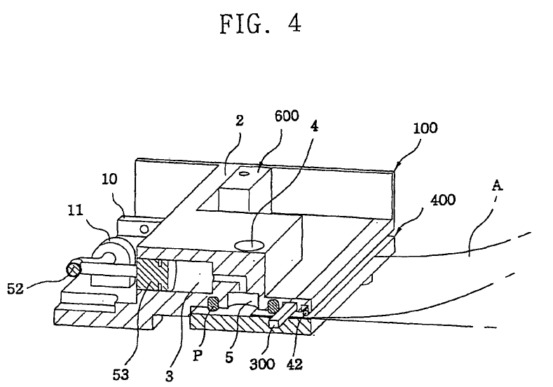

FIG. 5 is a perspective view of the vacuum packing machine according to the present invention, with an exhaust passage of the housing body cut away;

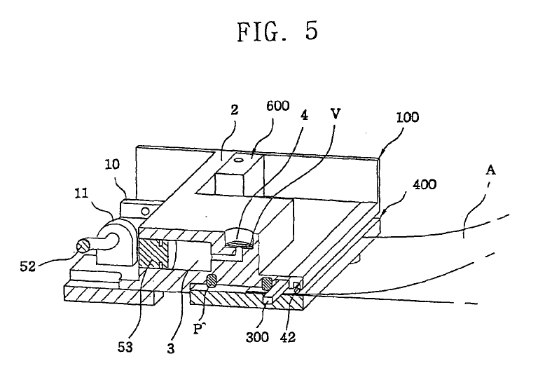

FIG. 6 is a side sectional view of the vacuum packing machine according to the present invention;

FIG. 7 is a bottom perspective view of the housing body, showing an air-channeled panel provided on the lower surface of the housing body according to the present invention;

FIG. 8 is a sectional view taken along the line A′-A′ of FIG. 3, to show an auxiliary vacuum pressure supply unit in detail;

FIG. 9 is a partially sectioned plan view of a vacuum packing machine according to another embodiment of the present invention, with a plurality of pistons being installed on the housing body; and

FIG. 10 is a side sectional view showing the state of vacuum packing a packing bag using only the housing body of the vacuum packing machine according to the present invention.

### BEST MODE FOR CARRYING OUT THE INVENTION

Reference should now be made to the drawings, in which the same reference numerals are used throughout the different drawings to designate the same or similar components.

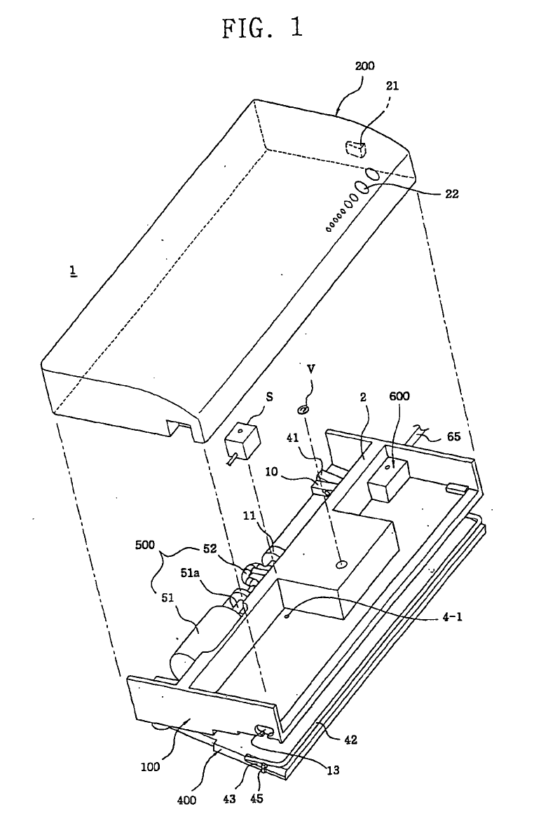

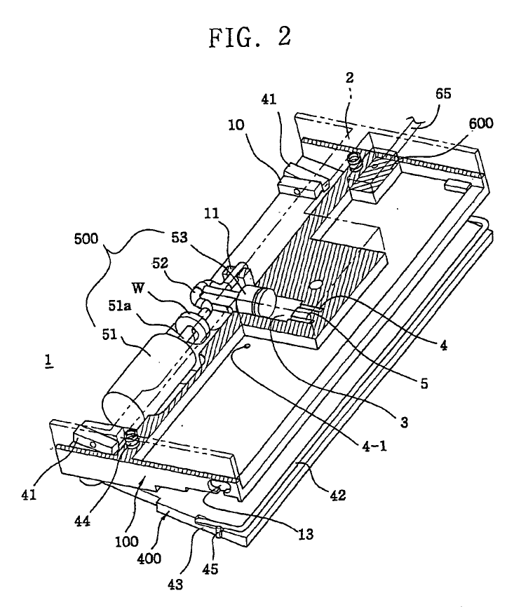

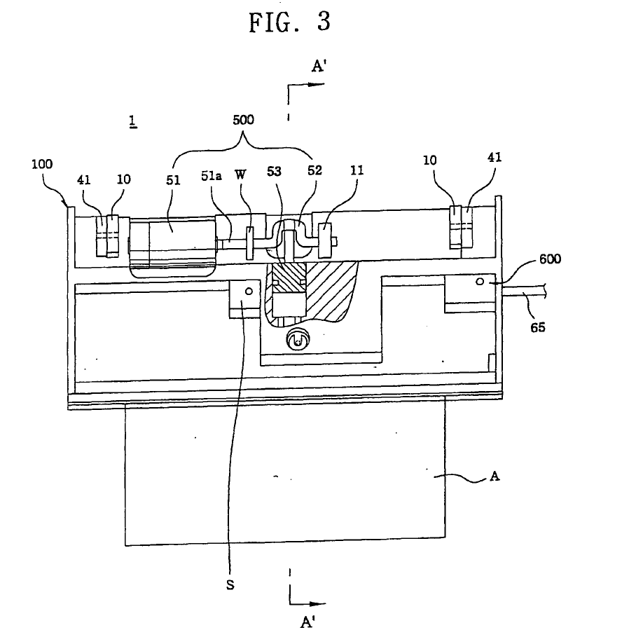

FIG. 1 is a perspective view of a vacuum packing machine according to the present invention, FIG. 2 is a perspective view of the vacuum packing machine of the present invention, horizontally broken away to show the interior construction, and FIG. 3 is a partially sectioned plan view of the vacuum packing machine according to the present invention.

The vacuum packing machine 1 of the present invention includes a housing body 100, atop cover 200, a thermal sealing means 300, a base 400, and a vacuum pressure generating means 500. The top cover 200 covers the upper part of the housing body 100, and is provided with a power switch 21 and a plurality of vacuum level control buttons 22 which are electrically connected to the power switch 21 and a control unit (not shown). The housing body 100 can be positioned at an open position with a predetermined open angle relative to the base 400. In this case, the housing body 100 is detachable from the base 400. The thermal sealing means 300 seals a packing bag A.

The housing body 100 includes a longitudinal partition wall 2 having a cylinder block. First and second depressions are formed on the housing body 100 at both sides of the partition wall 2. A cylinder 3 is horizontally formed in the cylinder block of the partition wall 2. An exhaust passage 4 extends from the cylinder 3 to the upper surface of the cylinder block. A sucking passage 5 extends from the lower surface of the housing body 100 to the cylinder 3. An air-channeled panel 6 is provided on the lower surface of the housing body 100 at a position corresponding to the sucking passage 5 for creating an air path. A closed edge groove 7 is formed on the lower surface of the housing body 100 along the edge of the air-channeled panel 6. A sealing member P having a loop shape is installed along the edge groove 7. A guide groove 8 of a predetermined depth is formed on the lower surface of the housing body 100 at a predetermined position spaced apart from the air-channeled panel 6 by a predetermined distance. A first seating groove 9 of a predetermined depth is longitudinally formed on the lower surface of the housing body 100 at a position around the guide groove 8. Two first hinge blocks 10 are projected at two positions of the upper surface of the housing body 100. A shaft bearing 11 is provided at a predetermined position between the two first hinge blocks 10. Support holes 12 are formed on the lower surface of the housing body 100 to have a predetermined depth. The support holes 12 hold support members as will be described later herein.

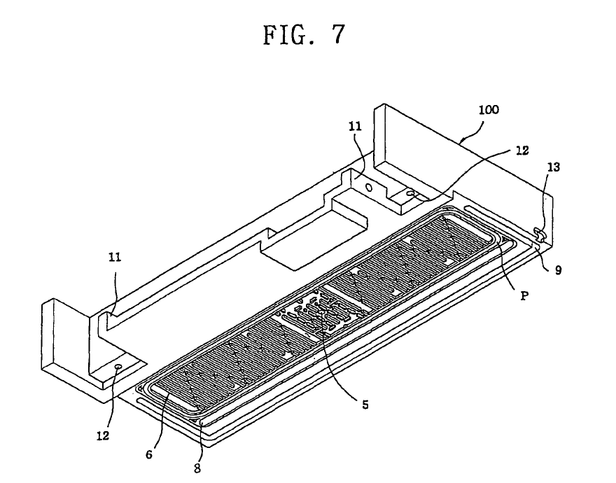

As shown in FIG. 7, the air-channeled panel 6 has a plurality of steps so that air circulates from the lower surface of the housing body 100 to the sucking passage 5.

When the sealing member P is installed along the edge groove 7 which is formed on the lower surface of the housing body 100 along the edge of the air-channeled panel 6, the sealing member P is projected downward such that the lower end of the sealing member P is positioned lower than the air-channeled panel 6.

The sealing member P is made of soft rubber or synthetic resin so as to allow vacuum pressure to be effectively generated in the air-channeled panel 6.

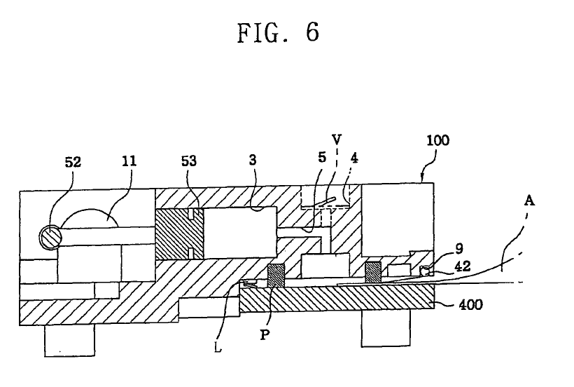

Referring to FIG. 6, the base 400 for supporting the housing body 100 includes two second hinge blocks 41. The second hinge blocks 41 are provided at two positions of the upper surface of the base 400 to join with the first hinge blocks 10 provided on the upper surface of the housing body 100. A holder 42 is installed on the base 400 such that both ends of the holder 42 are rotatably set on both side edges of the base 400, and holds a desired portion of the packing bag A. Second seating grooves 43 are formed on the both side edges of the base 400 so as to allow the both ends of the holder 42 to be positioned nearly horizontally. Two support members 44 are provided on the base 400 at positions around the second hinge blocks 41, and are held in the support holes 12.

Each of the support members 44 may be a compression spring, a plate spring, or an air cylinder-type actuator. In the preferred embodiment, a compression spring is used as each of the support members 44.

When the housing body 100 is closed to the base 400, the holder 42 is guided into the first seating groove 9 which is longitudinally formed on the lower surface of the housing body 100.

Since an air passage 4-1 extends from the upper surface of the housing body 100 to the air-channeled panel 6 and a solenoid valve S is set on the air passage 4-1 for releasing vacuum pressure, vacuum is automatically released after packing the bag A. When the vacuum is automatically released, the support members 44 upwardly bias the housing body 100 and the top cover 200 to position them at an open position.

The thermal sealing means 300 for sealing the packing bag A is longitudinally installed in the guide groove 8 which has a rectangular cross-section and is formed on the lower surface of the housing body 100. The thermal sealing means 300 is a heater which has a bar shape of a predetermined length, and is outwardly projected from both side ends of the guide groove 8. The lower surface of the thermal sealing means 300 is positioned on the same plane as the lower surface of the sealing member P, and is activated when power is applied to the thermal means 300.

Further, the vacuum pressure generating means 500 is mounted on the upper surface of the housing body 100. The vacuum pressure generating means 500 includes a drive motor 51. The drive motor 51 is mounted in the first depression of the housing body 100 for driving the vacuum pressure generating means 500. A crank shaft 52 is connected to a rotating shaft 51a of the drive motor 51, and supported by the shaft bearing 11 of the housing body 100. A piston 53 is connected at an end thereof to the crank shaft 52 by a connection rod, and set in the cylinder 3.

A weight device, such as a weight wheel W or a flywheel, is mounted on the rotating shaft 51a of the drive motor 51 for generating a rotating inertia moment of the rotating shaft 51a, thus accomplishing a reduction drive of the drive motor 51, preventing the rotating moment of the rotating shaft 51a from being reduced due to overload generated when packing the packing bag A, lengthening the life of the drive motor 51, and enhancing the efficiency of generating vacuum pressure.

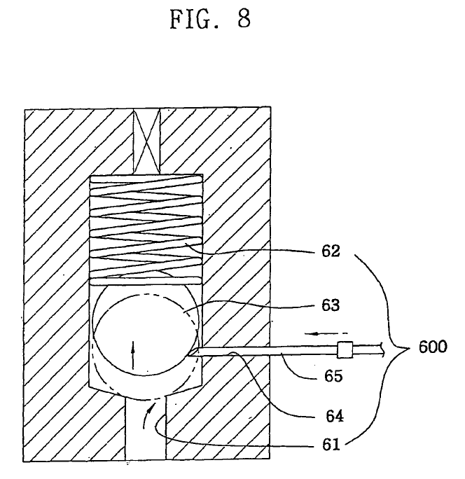

FIG. 8 is a sectional view taken along the line A′-A′ of FIG. 3, to show an auxiliary vacuum pressure supply unit 600 in detail. The auxiliary vacuum pressure supply unit 600 is installed in the second depression of the housing body 100 at a position above the air-channeled panel 6 for feeding vacuum pressure from a side of the housing body 100 to the outside. In this case, the auxiliary vacuum pressure supply unit 600 includes a compression spring 62 and a ball valve 63 which are set in a first actuating hole 61. The first actuating hole 61 extends from the air-channeled panel 6 to the upper surface of the housing body 100. The auxiliary vacuum pressure supply unit 600 also has a vacuum pressure supply pipe 65 which is set in a second actuating hole 64 in such a way as to be movable along the second actuating hole 64 for selectively actuating the ball valve 63 to open the first actuating hole 61. In this case, the second actuating hole 64 is formed in a side surface of the housing body 100 to communicate the first actuating hole 61 with the outside.

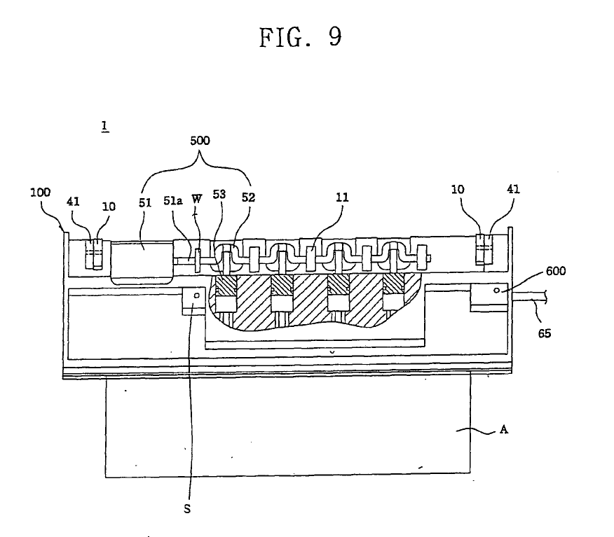

FIG. 9 is a partially sectioned plan view showing a vacuum packing machine according to another embodiment of the present invention. As shown in FIG. 9, one or more pistons 53 may be set in the housing body 100 according to desired magnitude of vacuum pressure to be generated. At this time, the number of bends of the crank shaft 52 are the same as that of the pistons 53. In addition, the same number of cylinders 3 as that of the pistons 53 is arranged at regular intervals in the cylinder block of the partition wall 2.

The operation and effect of the vacuum packing machine according to the present invention are described in the following.

As shown in FIG. 1, the housing body 100 with the top cover 200 is set on the base 400 in such a way as to be normally opened, in the form of a clamshell. When it is desired to pack a packing bag A which receives items therein, the open end of the packing bag A is primarily put into the open mouth between the base 400 and the housing body 100 which is open at a predetermined open angle. Thereafter, a user presses the housing body 100 downwards so as to close the housing body 100, and the power switch 21 provided on the top cover 200 is turned on. In such a case, a contact switch L installed on the lower surface of the housing body 100 is in contact with the base 400, thus starting the drive motor 51. Vacuum required for packing the packing bag A is thus generated.

The housing body 100 is rotatably installed on the base 400 by joining the two first hinge blocks 10 of the housing body 100 with the two second hinge blocks 41 of the base 400. The support members 44 which are provided on the base 400 at positions around the second hinge blocks 41 are held in the corresponding support holes 12 which are formed on the lower surface of the housing body 100, and normally bias the housing body 100 upwardly to make the body 100 positioned at the open position with a predetermined open angle relative to the base 400.

Preferably, the packing bag A has an air channel, a so-called “air path”. The air channel is formed on the inner surface of the packing bag at regular intervals. When the packing bag A is put in the open mouth between the housing body 100 and the base 400, the holder 42 which is rotatably installed on the base 400 serves to hold the open end of the packing bag A prior to generating vacuum pressure, thus allowing the packing bag A to be evenly packed and sealed. The holder 42 is guided to the second seating grooves 43 which are formed on the both side edges of the base 400 so as to allow the both ends of the holder 42 to be positioned nearly horizontally. In this case, the holder 42 is also received in the first seating groove 9 on the lower surface of the housing body 100 when the housing body 100 is completely closed to the base 400.

In such a case, the holder 42 is set on the upper surface of the base 400, but is guided into the first seating groove 9 when the housing body 100 is closed to the base 400. Therefore, the holder 42 does not interfere with the downward movement of the housing body 100.

The sealing member P, installed along the edge groove 7 which is formed on the lower surface of the housing body 100, is made of rubber, or synthetic resin, so that the packing bag A is compressed to some extent when the housing body 100 is closed to the base 400. But, the steps of the air-channeled panel 6 allow air to pass through the packing bag A, even when the sealing member P compresses the packing bag A.

Meanwhile, the process of generating or exhausting vacuum pressure in the housing body 100 is as follows.

As shown in FIG. 2, as the drive motor 51 mounted in the first depression of the housing body 100 is rotated, the crank shaft 52 connected to the rotating shaft 51a of the drive motor 51 is rotated. At this time, the piston 53 connected to the crank shaft 52 and set in the cylinder 3 moves rectilinearly so as to suck or exhaust air.

The air sucking process is as follows. First, when the piston 53 moves toward the outside end of the cylinder 3, air is sucked through the sucking passage 5 which extends from the air-channeled panel 6 on the lower surface of the housing body 100 to the cylinder 3. Such a process sucks air from the packing bag A containing items, thus forming a vacuum in the packing bag A.

The horizontal rectilinear moving distance of the piston 53 by the rotation of the crank shaft 52, that is, the stroke, is increased in comparison with a conventional vacuum pumping unit. That is, the cylinder 3 is directly formed in the housing body 100, so the stroke of the piston 53 by the rotation of the crank shaft 52 is maximized, thus remarkably enhancing the efficiency of generating vacuum pressure.

The weight wheel W is mounted on the rotating shaft 51a of the drive motor 51 which is connected to the crank shaft 52 moving the piston 53 rectilinearly, thus preventing the rotating force of the drive motor 51 from being reduced when the piston 53 is actuated, therefore effectively packing the packing bag A. That is, the weight wheel W increases the rotating moment of the motor 51, or RPM (revolution per minute) of the motor 51 thus preventing the output power of the drive motor 51 from being reduced when a vacuum state is about to be released.

In this case, air exhausted through the exhaust passage 4 extending from the cylinder 3 is controlled by a unidirectional control valve V so as to control the reciprocating movement of the piston 53. The unidirectional control valve V is installed on the exhaust passage 4 of the housing body 100. When the piston 53 moves toward the outside end of the cylinder 3, the unidirectional control valve V closes the exhaust passage 4 and generates vacuum pressure by sucking air from the sucking passage and the air-channeled panel 6 to the cylinder 3. On the contrary, when the piston 53 moves toward the inside end of the cylinder 3, the unidirectional control valve V opens the exhaust passage 4 so as to exhaust air from the cylinder 3.

As shown in the drawings, the vacuum may be generated by the auxiliary vacuum pressure supply unit 600 which is installed at a position defined by a side and the upper surface of the housing body 100, when the housing body 100 is closed to the base 400.

The auxiliary vacuum pressure supply unit 600 includes the compression spring 62 and the ball valve 63 which are set in the first actuating hole 61. The first actuating hole 61 extends from the air-channeled panel 6 to the upper surface of the housing body 100. The auxiliary vacuum pressure supply unit 600 also has the vacuum pressure supply pipe 65 which is set in the second actuating hole 64 in such a way as to be movable along the second actuating hole 64 for selectively opening the ball valve 63. In this case, the second actuating hole 64 is formed in the side surface of the housing body 100 to allow the first actuating hole 61 to communicate with the outside. When it is desired to form a vacuum in a packing bag A using such an auxiliary vacuum pressure supply unit 600, a hose (not shown) is first connected to the vacuum pressure supply pipe 65 and is inserted into the open end of a packing bag positioned outside the machine. Next, the piston 53 performs a pumping action so as to form a vacuum in the packing bag A which receives large-sized items, such as bulky sheets and blankets.

That is, when the piston 53 is actuated in the cylinder 3 by the drive motor 51, the vacuum pressure supply pipe 65 connected to the hose (not shown) is pushed in the housing body 100, and the inside end of the pipe 65 forcibly biases the ball valve 63 upward. At this time, since the air-channeled panel 6 communicates with the first actuating hole 61, a suction force is generated. It is possible to vacuum pack the packing bag A using the sucking force.

Such a vacuum packing method using the auxiliary vacuum pressure supply unit 600 is preferably used for packing a packing bag with a large-sized item or another item which makes it difficult to put the open end of the packing bag into the open mouth between the housing body 100 and the base 400.

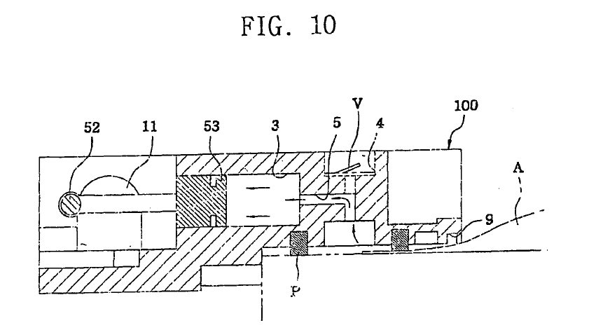

Furthermore, the housing body 100 may be independently used as it is detached from the base 400. As shown in FIG. 10, a packing bag A receiving an item is first laid on a flat surface, such as a table, a desk, and a shelf. Next, a user holds the housing body 100, and puts it on an open end of the packing bag A such that the sealing member P installed on the lower surface of the housing body 100 compresses the packing bag A. At this time, the power switch 21 is turned on, so vacuum pressure is generated by the operation of the drive motor 51, the crank shaft 52 and the rectilinear movement of the piston 53, thus vacuum packing the bag A. Such a packing method is particularly useful for a store which frequently uses the vacuum packing machine 1, or for an item which is difficult to carry.

When vacuum packing the packing bag A in such a way, a user confirms, with his/her eyes, whether a vacuum is generated in the packing bag A or not. When vacuum is generated in the packing bag A, the packing bag A is sealed by the thermal sealing means 300 which is installed on the lower surface of the housing body 100.

FIG. 9 is a partially sectioned plan view showing a vacuum packing machine according to another embodiment of the present invention. As shown in FIG. 9, a plurality of cylinders 3 and the same number of pistons 53 as that of the cylinders 3 are installed in the housing body 100. In addition, the bends of the crank shaft 52 connected to the pistons 53 and the shaft bearings T1 are different from the primary embodiment, in their numbers and positions. Such a construction allows the level of vacuum pressure to be increased with the use of a single drive motor 51.

As described above, the vacuum pressure generating means 500 generates vacuum pressure by the rotation of the drive motor 51. At this time, the number of the cylinders 3 and the pistons 53 are increased, so larger vacuum pressure is generated. It thus takes a short time to pack the packing bag A.

The vacuum packing machine 1 is designed to be portable. When it is not in use, the housing body 100 is closed to the base 400, and two locking lugs 45 provided on both side surfaces of the base 400 are rotated so as to be locked to two locking holes 13 formed on both side surfaces at a front portion of the housing body 100. As such, the housing body 100 is closed and the two locking lugs 45 are locked to the two locking holes 13, thus minimizing the inflow of impurities into the vacuum packing machine through the gap between the housing body 100 and the base 400, therefore keeping the vacuum packing machine 1 clean.

As such, when the housing body 100 is closed to the base 400, the contact switch L installed on the lower surface of the housing body 100 may be in contact with the base 400. However, the power switch 21 provided on the top cover 200 interrupts an electric current so that the vacuum pressure generating means 500 is not driven.

Meanwhile, when the vacuum packing machine 1 is in use, and the housing body 100 is closed to the base 400, vacuum pressure is generated and the thermal sealing means 300 seals the packing bag A. When finishing sealing the packing bag A, air remaining in the air-channeled panel 6 eccentrically actuates the solenoid valve S set on the housing body 100. Vacuum pressure is thus released by the operation of the solenoid valve S. As the vacuum pressure is released, the housing body 100 moves upwardly and automatically to be opened from the base 400.

At this time, the support members 44 provided on the base 400 upwardly biases the housing body 100, so the housing body 100 is positioned at an open position for packing another packing bag.

### Industrial Applicability

As described above, the present invention provides a vacuum packing machine, which is designed such that one or more cylinders, a sucking passage, an exhaust passage, one or more pistons and a drive motor are directly mounted in a housing body for vacuum packing a packing bag laid under the lower surface of an air-channeled panel, and which is designed such that the housing body is detachable from a base, and which remarkably increases vacuum pressure according to the number of the cylinders and pistons, and which is conveniently used in home or stores.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A Vacuum packing machine comprising:
a housing body including:
a longitudinal partition wall having a cylinder block, with first and second depressions formed on the housing body of both sides of said partition wall;
a cylinder horizontally set in said cylinder block of the partition wall;
an exhaust passage extending from the cylinder to an upper surface of the cylinder block;
a sucking passage extending from a lower surface of the housing body of the cylinder;
an air-channeled panel provided on the lower surface of the hosing body at a position corresponding to the sucking passage for creating an air path;
an edge groove formed on the lower surface of the hosing body along an edge of the air-channeled panel, with a sealing member being installed along the edge groove;
a guide groove of a predetermined depth formed on the lower surface of the housing body at a predetermined position spaced apart from the air-channeled panel by a predetermined distance;
a first seating groove of a predetermined depth longitudinally formed on the lower surface of the housing body at a position around the guide groove;
two first hinge blocks projected at two positions of an upper surface of the housing body;
a shaft bearing provided at a predetermined position between the two first hinge blocks; and
support holes formed on the lower surface of the housing body to have predetermined depth;
a top cover covering an upper part of the housing body, and provided with a power switch and a plurality of vacuum level control buttons electrically connected to the power switch;
thermal sealing mean longitudinally installed in the guide groove on the lower surface of the housing body for sealing an open end of the packing bag;
a base including:
two second hinge blocks provided at two positions of an upper surface of the base to join with said first hinge blocks provided on the upper surface of the housing body;
a holder installed on the base such that both ends of the holder are rotatably set on both side edges of the base, and holding a predetermined portion of the packing bag;
second seating grooves formed on the both side edges of the base for allowing the both ends of the holder to be positioned nearly horizontally;
support members provided on the base at positions around the second hinge blocks and normally biasing the housing body upward to position the body at an open position with a predetermined open angle; and
vacuum pressure generating means including:
a drive motor mounted on the first depression of the housing body;
a crank shaft connected at a first end thereof to a rotating shaft of the drive motor, and supported at a second end thereof by the shaft bearing of the housing body; and
a piston connected at an end thereof to the crank shaft, and set in the cylinder.

2. The vacuum packing machine according to claim 1, wherein an air passage extends from the upper surface of the housing body to the air-channeled pane, with a solenoid valve being set on the air passage for releasing vacuum pressure.

3. The vacuum packing machine according to claim 1, wherein two locking holes are formed on both side surfaces at a front portion of the housing body, and two locking lugs are provided on both side surfaces of the base to be locked to the locking holes.

4. The vacuum packing machine according to claim 1, wherein a contact switch is installed at a predetermined position on the base for driving the vacuum pressure generating means when the hosing body is closed to the base and the contact switch is in contact with the lower surface of the housing body.

5. The vacuum packing machine according to claim 1, wherein a weight wheel is mounted on the rotating shaft of said drive motor for generating a rotating inertia moment of said rotating shaft.

6. The vacuum packing machine according to claim 1, wherein an auxiliary vacuum pressure supply unit is installed on the second depression of the housing body at a position above the air-channeled panel for feeding vacuum pressure from a side of the housing body to the outside.

7. The vacuum packing machine according to claim 6, wherein the auxiliary vacuum pressure supply unit comprises:
a compression spring and a ball valve set in a first actuating hole, said first actuating hole extending from the air-channeled panel to the upper surface of the housing body; and
a vacuum pressure supply pipe set in a second actuating hole in such a way as to be movable along the second actuating hole for selectively opening the ball valve, said second actuating hole formed in a side surface of the housing body to communicate the first actuating hole with the outside.

8. The vacuum packing machine according to claim 1, wherein one or more cylinders are arranged in the housing body along a longitudinal direction, and the same number of pistons as that of the cylinders are connected to the crank shaft.

9. The vacuum packing machine according to claim 1, wherein each of the said support members comprises a compression spring, a plate spring and an air cylinder-type actuator.

10. The vacuum packing machine according to claim 1, wherein a unidirectional control valve is installed on the exhaust passage of the hosing body.

11. A vacuum packaging machine suitable for evacuating and sealing a vacuum packaging bag, said vacuum packaging machine comprising:
a housing body;
a base;
a vacuum chamber formed between said housing body and said base, said vacuum chamber arranged to receive an open end of said vacuum packaging bag;
a vacuum pressure apparatus disposed within said vacuum packaging machine and external to said vacuum chamber, said vacuum pressure apparatus including a piston, said vacuum pressure apparatus coupled to said vacuum chamber via a passage structure formed from said housing body and said base and directly opening into said vacuum chamber, said piston substantially disposed within said passage, wherein operation of said piston evacuates said vacuum chamber.

12. A vacuum packaging machine as recited in claim 11, wherein said housing body and said base are mechanically coupled such that said housing body may open from said base to receive said vacuum packaging bag, and said housing body may close on said base to engage said vacuum packaging bag and hermetically seal said vacuum chamber.

13. A vacuum packaging machine as recited in claim 11, said vacuum packaging machine further comprising a heat sealing mechanism arranged to seal said open end of said vacuum packaging bag.

14. A vacuum packaging machine as recited in claim 11, wherein said passage structure formed from said housing body and said base includes an evacuation passage and an exhaust passage.

15. A vacuum packaging machine as recited in claim 11, wherein said vacuum pressure apparatus includes a plurality of pistons housed within a plurality of passage structures for evacuating said vacuum chamber.

16. A vacuum packaging machine suitable for evacuating a vacuum packaging bag, said vacuum packaging machine comprising:
a housing body including a sealing gasket surrounding an open vacuum chamber formed within said housing body, and a vacuum pressure apparatus coupled to said open vacuum chamber and operable to evacuate said open vacuum chamber; and
wherein said sealing gasket and said open vacuum chamber are operable to receive an open end of said vacuum packaging bag such that a user may engage said sealing gasket with a flat gas-impermeable surface thereby hermetically sealing said open vacuum chamber enabling vacuum evacuation of said vacuum packaging bag.

17. A vacuum packaging machine as recited in claim 16 further comprising a base that may be pivotably and detachably attached to said housing body, said base providing a means assisting in engaging said vacuum packaging bag for evacuation.

18. A vacuum packaging machine as recited in claim 16, wherein said vacuum pressure includes a piston, said vacuum pressure apparatus coupled to said open vacuum chamber via a passage structure formed from said housing body and directly opening into said vacuum chamber, said piston substantially disposed within said passage, wherein operation of said piston evacuates said open vacuum chamber.

19. A vacuum packaging machine as recited in claim 16 further comprising a heat sealing mechanism suitable for heat sealing said open end of said vacuum packaging bag.

20. A vacuum packaging machine as recited in claim 16, wherein said vacuum pressure apparatus includes a plurality of pistons housed within a plurality of passage structures for evacuating said open vacuum chamber.

21. A vacuum packaging machine suitable for evacuating a vacuum packaging bag coupled to a vacuum chamber, said vacuum packaging machine characterized in that a vacuum mechanism is directly coupled to said vacuum chamber of said vacuum packaging machine, whereby the direct coupling of said vacuum chamber to said vacuum packaging machine tends to improve efficiency of the evacuation of said vacuum chamber.
